(19) United States
(12) Patent Application Publication
(10) Pub. No.: US 2007/0145905 A1
(43) Pub. Date: Jun. 28, 2007

(54) Driver device for a gas discharge lamp and igniter

(75) Inventor: Ronald Hans Van Der Voort, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,175

(22) PCT Filed: Feb. 15, 2005
(86) PCT No.: PCT/IB05/50574

§ 371 Date: Aug. 21, 2006

(30) Foreign Application Priority Data
Feb. 25, 2004 (EP) 04100731.1

(51) Int. Cl. F02P 3/08

(52) U.S. Cl. 315/209 CD

(57) ABSTRACT

An igniter circuit (140) for an electronic lamp driver (100) for driving a gas discharge lamp (6) is described, the igniter circuit comprising: first and second supply input terminals (102, 103); a switch branch (110) comprising a first controllable ignition switch (111) and a second controllable ignition switch (112) connected in series between said first and second supply input terminals (102, 103); a transformer (33) having a primary winding (41) and a secondary winding (32); an igniter coil (42) connected in series with said primary transformer winding (41), this series arrangement having one end (42b) connected to a node (D) between said two controllable ignition switches (111, 112); a storage capacitor (44) connected between another end (41b) of said series arrangement and one of the supply input terminals (102, 103).

### FIELD OF THE INVENTION

The present invention relates to a driver device for a gas discharge lamp, specifically a HID (High Intensity Discharge) lamp. Specifically, the present invention relates to a driver device of HBCF type. More specifically, the present invention relates to an igniter circuit for such driver device.

### BACKGROUND OF THE INVENTION

A high-pressure discharge lamp is typically operated by supplying commutating DC current (this will be indicated as a square wave current). On the other hand, discharge lamps require high-voltage pulses for ignition. These pulses have to cause a breakdown in the gas discharge vessel. The open circuit voltage has to be sufficiently high to provide take-over, i.e. sustaining a current in the ignited lamp. From this moment, the lamp power will rise to its nominal value (run-up). The ignition pulses as mentioned have a magnitude in the order of 3-5 kV.

Conventional (electromagnetic) equipment involves a ballast choke to stabilise the lamp and an igniter to ignite the lamp, wherein the igniter provides the ignition pulses. Nowadays, conventional equipment is more and more replaced by electronic equipment. This electronic equipment combines the functions of lamp power control and ignition, often together with mains power factor correction, in one electronic circuit or ballast.

A well-known conventional driver has a three-stage design. A first stage comprises an up-converter which receives rectified AC mains input voltage and converts this input voltage to a higher DC output voltage. A second stage comprises a down-converter which receives the DC output voltage from the up-converter, and provides at its output a lower DC voltage (lamp voltage) and a required lamp current. This down-converter has a current source characteristic, i.e. it controls the lamp current to a substantially constant value. A third stage comprises a commutator which regularly changes the direction of the lamp current, at a frequency typically in the order of about 100 Hz. In other words, although, during steady state operation, the lamp is operated at substantially constant current magnitude, the lamp current regularly changes its direction within a very brief time (commutating period).

An alternative design, having the advantage of having less components and therefore reduced costs, has a two-stage design wherein the function of lamp current control and commutation are combined into one stage. Thus, such a two-stage electronic ballast comprises a first stage up-converter, also indicated as pre-conditioner, for receiving rectified AC mains input voltage and providing a higher DC output voltage. As a second stage, this two-stage electronic ballast comprises a half-bridge commutating forward stage (HBCF).

In general, such HBCF comprises three branches. A first branch comprises two switches, typically MOSFETs, connected in series between input terminals receiving the DC voltage from the pre-conditioner; this first branch will hereinafter also be indicated as switch branch. A second branch comprises two capacitors connected in series between said two input terminals; this second branch will hereinafter also be indicated as capacitor branch. A third branch, comprising the lamp and also indicated as lamp branch, is connected between on the one hand the node between said two switches and on the other hand the node between said two capacitors. A switch controller generates control signals for controlling the timing of the switches.

A full lamp period comprises a first time interval where the lamp current has one direction, and a second time interval where the lamp current has the reverse direction. During each of these intervals, one of said two switches can be indicated as active, while the other can be indicated as passive. The active switch is switched open (non-conductive state) and closed (conductive state) at a relatively high frequency. During the closed condition of this active switch, lamp current is conducted by this active switch and increases in magnitude. During the open condition of this active switch, the lamp current is conducted by a diode in parallel to the other switch, i.e. the passive switch. This diode may be the internal body diode of the MOSFET switch itself.

U.S. Pat. No. 6,188,183 describes an electronic ballast for a gas discharge lamp, comprising a commutator stage with HBCF topology. During an ignition phase, the switch controller generates its control signals such that the HBCF components themselves generate high-frequency ignition pulses; after ignition, the switch controller generates its control signals such that the HBCF components generate commutating DC current for steady state operation.

In steady state operation, it is desirable that any high-frequency rimple is as low as possible in order to avoid the risk of acoustical resonance. To this effect, the HBCF commutator stage also comprises filter components, filtering out high-frequency components of the lamp current. On the other hand, the HBCF components should be capable of producing high-frequency ignition pulses during ignition. This leads to conflicting requirements for components of the driver, so that a driver where ignition pulses are provided by the steady state current generating components is usually a compromise between these requirements. Particularly, it is very difficult to separately optimise the steady state lamp driving function and the ignition function.

FIG. 1 is a block diagram schematically illustrating a prior art electronic ballast with a separate ignition circuit. The ballast 1 has input terminals 2 and 3 for receiving a DC voltage from a pre-conditioner (not shown); this DC voltage typically ranges in the order of about 400 V in the case of lamps requiring typically in the order of 200 V supply voltage. It will be assumed that the voltage level V_{H} at the first input terminal 2 is higher than the voltage level V_{L} at the second input terminal 3. The ballast 1 comprises a switch branch 10 comprising two switches (MOSFETs) 11 and 12 connected in series between said input terminals 2, 3; a node between said two switches 11 and 12 is indicated at A. A switch controller 13 generates control signals for controlling the timing of the switches 11 and 12. A capacitor branch 20 comprises two capacitors 21 and 22 connected in series between said two input terminals 2, 3; a node between said two capacitors 21 and 22 is indicated at B. The voltage level at this node B is typically equal to about (V_{H}+V_{L})/2.

A lamp branch 30 is connected between said two nodes A and B. The lamp branch 30 comprises a series connection of output terminals 4 and 5 for connecting a lamp 6, a lamp coil 31, and a secondary winding 32 of a transformer 33. First and second filter capacitors 34 and 35 are connected between on the one hand the node C between lamp coil 31 and secondary transformer winding 32, and on the other hand the first and second input terminals 2 and 3, respectively. An igniter capacitor 36 is connected in parallel to the secondary transformer winding 32.

The transformer 33 and the igniter capacitor 36 are part of an ignition circuit 40. The transformer 33 has a primary winding 41 having one terminal 41a connected to a first terminal 42a of an igniter coil 42. A controllable switch 43 connects a second terminal 42b of the igniter coil 42 to the second input terminal 3. The ignition circuit 40 further comprises a storage capacitor 44 connected between a second terminal 41b of the primary transformer winding 41 and the second input terminal 3, and a charging resistor 45 connected between the second terminal 41b of the primary transformer winding 41 and the first input terminal 2.

It is noted that variations to this design are possible; for instance, the igniter capacitor 36 may be connected in parallel to the primary transformer winding 41.

The operation of this prior art ignition circuit 40 is as follows. Initially, the controllable switch 43 is open (non-conductive), and the storage capacitor 44 is charged to the voltage at the first input terminal 2 by a charging current conducted by the charging resistor 45. Then, the controllable switch 43 is closed (conductive), and the storage capacitor 44 discharges via the primary transformer winding 41 and the igniter coil 42. The current in the primary transformer winding 41 is coupled to the secondary transformer winding 32, and hence to the lamp 6.

A disadvantage of this prior art circuit is that it can in principle provide only one ignition pulse. If the lamp does not start on this one pulse, a next pulse can only be delivered after the storage capacitor 44 will have been recharged.

Another disadvantage of this prior art circuit is that the full discharge current flows through the switch 43, so that this switch 43 has to be a relatively expensive power-MOSFET.

Another disadvantage of this prior art circuit is that the storage capacitor 44 is resistively charged via the charging resistor 45.

Another disadvantage of this prior art circuit is that, for generating adequate ignition pulses, the storage capacitor 44 has to be charged to a relatively high voltage; consequently, the voltage difference between the input terminals 2 and 3 must be relatively high, and the components of the actual lamp driver circuit 10, 20, 30 must have a rating suitable for this high voltage.

A further disadvantage relates to the take-over phase, immediately after discharge. For sustaining a lamp current during the take-over phase, in sometimes appears necessary to increase the bus voltage (i.e. V_{H}−V_{L}) by approximately 100 V.

A general objective of the present invention is to provide an igniter circuit for a gas discharge lamp driver which eliminates or at least reduces all or at least one of the above-mentioned problems.

### SUMMARY OF THE INVENTION

According to an important aspect of the present invention, an igniter circuit for a discharge lamp driver comprises a half-bridge resonant circuit, separate from the steady state driver circuit. In operation, the storage capacitor can be recharged via the igniter coil, thus again using the energy accumulated in the igniter coil during discharge. The circuit can be operated resonantly, and can constantly provide ignition pulses at a repetition rate determined mainly by the resonance frequency of the circuit. Thus, the lamp 6 will be ignited more rapidly. After ignition, once the lamp electrodes are at thermionic emission, the igniter circuit can be switched off, but, if desired, the operation of the igniter circuit can be continued to support lamp discharge in difficult operating conditions.

A further advantage of a resonant circuit is that it is possible to provide sufficient lamp voltage, and to provide sufficient energy input into the lamp for sustaining the lamp during the take-over phase, without it being necessary to increase the bus voltage.

A further advantage is that, during resonant operation, the current in the half-bridge switches of the igniter circuit is relatively small, so that these switches can be relatively small and inexpensive.

A further advantage is that the igniter function is fully separated from the steady state function, so that the lamp driver can be optimised for steady state operation and can simultaneously be optimised for ignition. Especially, it is made easily possible to operate lamp driver in a preferred stead state operating mode, i.e. critical discontinuous mode. Further, component values for resonant ignition and component values for filtering in steady state operation can be optimally selected independently from each other, without the need to compromise.

A further advantage is that the input voltage to the lamp driver can be set at a lower value, so that components with a lower voltage rating and/or better properties and performance can be used. Also, circuit efficiency is improved.

### BRIEF DESCRIPTION OF THE DRAWINGS

These and other aspects, features and advantages of the present invention will be further explained by the following description of a preferred embodiment of the lamp driver according to the present invention with reference to the drawings, in which same reference numerals indicate same or similar parts, and in which:

FIG. 1 is a block diagram schematically illustrating a prior art electronic ballast with a separate ignition circuit;

FIG. 2 is a block diagram schematically illustrating an electronic ballast with a separate ignition circuit in accordance with the present invention;

FIG. 3 is a graph illustrating a quality factor as function of operating frequency.

### DESCRIPTION OF THE INVENTION

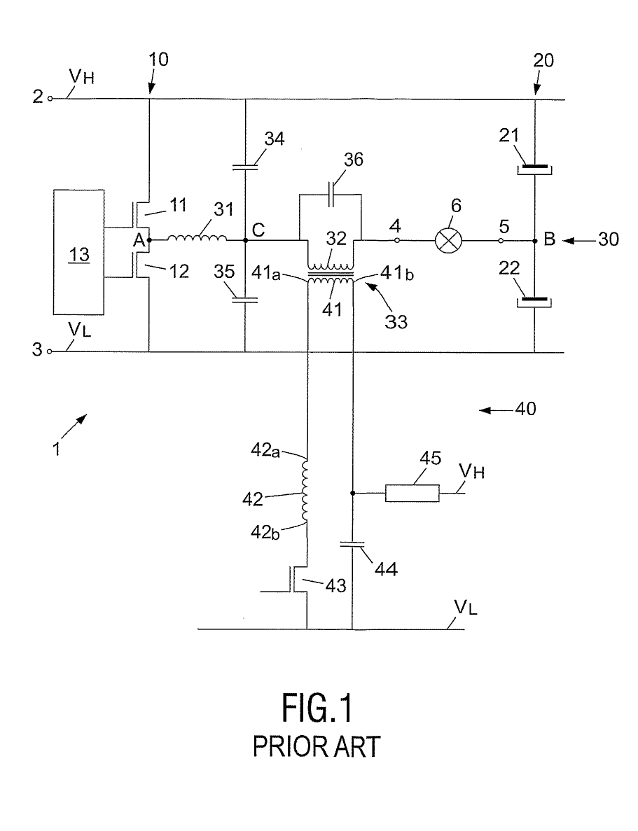

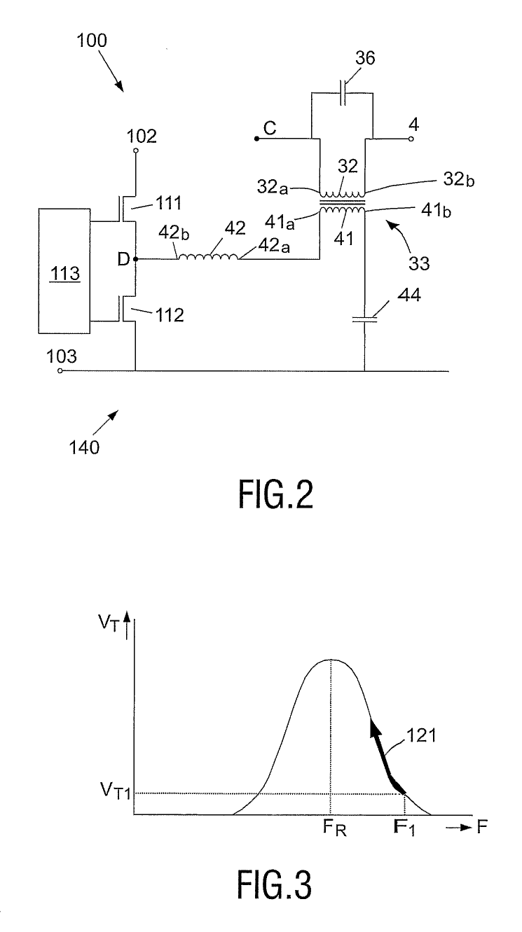

FIG. 2 schematically shows a block diagram of an electronic ballast 100 according to the present invention, which comprises an ignition circuit 140 designed in accordance with the present invention. Many components of the ballast 100 may be identical to corresponding components of the prior art ballast 1. Therefore, in FIG. 2, such components have the same reference numeral as in FIG. 1, or are even omitted for sake of simplicity, and their description will not be repeated here.

Like in the prior art circuit, the ignition circuit 140 comprises a transformer 33, having its secondary winding 32 connected in series with the lamp 6, between node C and lamp output terminal 4. In fact, the ignition circuit 140 in accordance with the present invention may be implemented as a separate replacement circuit for replacing existing ignition circuitry; in such case, the terminals 32a and 32b of the secondary transformer winding 32 may be considered as constituting output terminals of the ignition circuit 140.

The ignition circuit 140 has input terminals 102 and 103 for receiving a DC voltage. It will be assumed that the voltage level at the first input terminal 102 is higher than the voltage level at the second input terminal 103. In principle, these two input terminals 102 and 103 may be connected to a separate voltage source. Normally, however, the high-voltage input terminal 102 will be connected to first input terminal 2 of the ballast 100, and the low-voltage input terminal 103 will be connected to second input terminal 3 of the ballast 100.

The transformer 33 has a primary winding 41 having one terminal 41a connected to a first terminal 42a of an igniter coil 42. The ignition circuit 140 further comprises a storage capacitor 44 connected between a second terminal 41b of the primary transformer winding 41 and the low-voltage input terminal 103. It is noted that, alternatively, the storage capacitor 44 may be connected between the primary transformer winding 41 and the high-voltage input terminal 102.

With reference to FIG. 1, it is noted that the second terminal 41b of the primary transformer winding 41 may also be connected to node B of the capacitor branch 20, in which case the storage capacitor 44 may be omitted.

The ignition circuit 140 comprises a switch branch 110 comprising two switches (MOSFETs) 111 and 112 connected in series between said high-voltage input terminal 102 and said low-voltage input terminal 103; a node between said two switches 111 and 112 is indicated at D. A switch controller 113 generates control signals for controlling the timing of the switches 111 and 112.

The second terminal 42b of the igniter coil 42 is connected to said node D between said two switches 111 and 112.

The operation of the inventive ignition circuit 140 is as follows.

The ignition switch controller 113 alternates between two control states: in a first control state, the ignition switch controller 113 generates its control signals such that the first igniter switch 111 is closed (conductive) while the second igniter switch 112 is open (non-conductive), whereas in a second control state, the ignition switch controller 113 generates its control signals such that the first igniter switch 111 is open (non-conductive) while the second igniter switch 112 is closed (conductive). Thus, an alternating current is generated in the first transformer winding 41, leading to an alternating current in the second transformer winding 32. In a preferred embodiment, the magnetising inductivity of the transformer 33 is smaller than the inductivity of igniter coil 42, so that the magnetising inductivity of the transformer 33, in combination with igniter capacitor 36, is dominant in determining the resonance frequency of the circuit. In that case, the currents in the igniter capacitor 36 and the magnetising inductivity of the transformer 33 have substantially the same magnitude and substantially 180° phase difference, so that the summation of these currents, which flows through igniter coil 42, is only small, hence the current in igniter switches 111 and 112 is relatively small.

In the above, the magnetising inductivity of the transformer 33 indicates the combined inductivities of the first and second windings of the transformer, as will be clear to a person skilled in the art.

The voltage generated over the first transformer winding 41 depends on the switching frequency. FIG. 3 is a graph showing transformer voltage V_{T} (vertical axis, arbitrary units) as a function of switching frequency F (horizontal axis, arbitrary units) It can be seen that the transformer voltage V_{T} has a maximum when the switching frequency F is equal to the resonance frequency F_{R} of the series connection of the first transformer winding 41 and the storage capacitor 44.

Although it is possible that the ignition switch controller 113 operates at one fixed frequency, the preferred operation is as follows. When operation starts (i.e. the driver 100 is switched on), the ignition switch controller 113 starts controlling the ignition switches 111 and 112 at an initial frequency F₁ at some distance from the resonance frequency F_{R}. Here, the transformer voltage V_{T} is relatively low (V_{T1}), but the resonance circuit will start to resonate relatively quickly. The initial frequency F₁ may be selected lower than the resonance frequency F_{R}, but preferably the initial frequency F₁ is selected higher than the resonance frequency F_{R}, as shown.

Then, the ignition switch controller 113 reduces the difference between its operating frequency and the resonance frequency F_{R}, i.e. it reduces its operating frequency, such that the transformer voltage V_{T} increases, indicated by line 121 in FIG. 3.

The ignition switch controller 113 may be designed to continue until its operating frequency is identical to the resonance frequency. It is also possible that the ignition switch controller 113 monitors the transformer voltage V_{T} (by using a sensor not shown in FIG. 3), and fixes its operating frequency as soon as the transformer voltage V_{T} exceeds a predetermined level.

An igniter having the above-operation will be indicated as “resonant igniter”.

The operation of the ignition switch controller 113 is independent from the operation of the lamp driver switch controller 13. Particularly, it is possible that the ignition switch controller 113 continues operation during take-over, and even during steady state operation of the lamp, if desired.

Further, since the igniter circuit 140, apart from the secondary transformer winding 32, has no components in common with the lamp current generating circuit, the igniter circuit 140 and the lamp current generating circuit may be optimised independently from each other.

It should be clear to a person skilled in the art that the present invention is not limited to the exemplary embodiments discussed above, but that several variations and modifications are possible within the protective scope of the invention as defined in the appending claims.

For instance, in the embodiment discussed, the storage capacitor 44 is connected between the primary transformer winding 41 and the low-voltage input terminal 103; alternatively, the storage capacitor 44 might be connected between the primary transformer winding 41 and the high-voltage input terminal 102.

In the above, the present invention has been explained with reference to block diagrams, in which switch controllers are illustrated as functional blocks. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Igniter circuit (140) for an electronic lamp driver (100) for driving a gas discharge lamp (6), the igniter circuit comprising:
first and second supply input terminals (102, 103);
a switch branch (110) comprising a first controllable ignition switch (111) and a second controllable ignition switch (112) connected in series between said first and second supply input terminals (102, 103);
a transformer (33) having a primary winding (41) and a secondary winding (32);
an igniter coil (42) connected in series with said primary transformer winding (41), this series arrangement having one end (42b) connected to a node (D) between said two controllable ignition switches (111, 112);
a storage capacitor (44) connected between another end (41b) of said series arrangement and one of the supply input terminals (102, 103).

2. Igniter circuit according to claim 1, further comprising an igniter capacitor (36) connected in parallel to said secondary transformer winding (32).

3. Igniter circuit according to claim 1, further comprising an ignition switch controller (113) for controlling the two controllable ignition switches (111, 112).

4. Igniter circuit according to claim 1, wherein the igniter coil (42) has a first end terminal (42a) connected to a first end terminal (41a) of the primary transformer winding (41), and has a second end terminal (42b) connected to said node (D) between said two controllable ignition switches (111, 112).

5. Igniter circuit according to claim 4, wherein the storage capacitor (44) is connected between a second end terminal (41b) of the primary transformer winding (41) and one of the supply input terminals (102, 103).

6. Igniter circuit according to claim 4, wherein the storage capacitor (44) is connected between the second end terminal (41b) of the primary transformer winding (41) and the low-voltage input terminal (103).

7. Igniter circuit according to claim 1, wherein the magnetising inductivity of the transformer (33) is smaller than the inductivity of igniter coil (42).

8. Method for operating the igniter circuit (140) of claim 1, comprising the steps of:
in a first state, closing the first ignition switch (111) and opening the second ignition switch (112);
in a second state, opening the first ignition switch (111) and closing the second ignition switch (112);
alternating between said first and second states at a switching frequency (F).

9. Method according to claim 8, wherein the switching frequency (F) is selected to be at least approximately equal to the resonance frequency (F_{R}) of the series connection of the first transformer winding (41) and the storage capacitor (44).

10. Method according to claim 9, further comprising the steps of:
initially, selecting the switching frequency (F) to be higher than said resonance frequency (F_{R});
subsequently, lowering the switching frequency (F) until the amplitude of the voltage over the first transformer winding (41) reaches a maximum.

11. Method according to claim 9, further comprising the steps of:
initially, selecting the switching frequency (F) to be higher than said resonance frequency (F_{R});
subsequently, lowering the switching frequency (F) until the amplitude of the voltage over the first transformer winding (41) reaches a predetermined level.

12. Method according to claim 8, wherein operating the igniter circuit (140) is continued even after ignition of a lamp (6) connected in series with the secondary transformer winding (32).

13. (canceled)

14. Driver circuit (100) for driving a gas discharge lamp (6), comprising an igniter circuit (140) according to claim 1.

15. Driver circuit according to claim 14, having HBCF topology comprising:
first and second supply input terminals (2, 3) for receiving first and second supply voltages (V_{H}, V_{L}), respectively;
a switch branch (10) comprising a first controllable driver switch (11) and a second controllable driver switch (12) connected in series between said first and second supply input terminals (2, 3), the switch branch having a first node (A) between said two driver switches (11, 12);
a capacitor branch (20) comprising a first capacitor (21) and a second capacitor (22) connected in series between said first and second supply input terminals (2, 3), the capacitor branch (20) having a second node (B) between said two capacitors (212 22);
a lamp branch (30) comprising output terminals (4, 5) for connecting a lamp (6), the lamp branch (30) being connected between said first and second nodes (A, B);
the lamp branch (30) comprising the secondary transformer winding (32) connected in series with said lamp output terminals (4, 5).

16. Driver circuit according to claim 14, wherein the first and second supply input terminals (102, 103) of the igniter circuit (140) are connected to the first and second supply input terminals (2, 3) of the driver circuit, respectively.
